(19) United States
(12) Patent Application Publication
(10) Pub. No.: US 2019/0281340 A1
(43) Pub. Date: Sep. 12, 2019

(54) FULL IMMERSION VIDEO SYSTEM IN A MULTI-PASSENGER VEHICLE

(71) Applicant: Stephen M. Sacra, Scottsdale, AZ (US)

(72) Inventor: Stephen M. Sacra, Scottsdale, AZ (US)

(21) Appl. No.: 15/917,477

(22) Filed: Mar. 9, 2018

(51) Int. Cl. H04N 21/414; B60R 11/02; B60K 35/00

(52) U.S. Cl. CPC H04N 21/41422; B60R 11/0235; B60K 2350/1028; B60K 2350/106; B60K 2350/922; B60K 35/00

(57) ABSTRACT

A passenger compartment of a vehicle includes an overhead video display mounted horizontally proximate the vehicle roof vehicle, and at least one vertical video display mounted proximate the forward or rearward edge of the overhead video display. A computer mounted within the vehicle is coupled to the overhead and vertical video displays for sending coordinated video images thereto, whereby video images appear to travel continuously between the overhead and vertical video displays. A control panel provided in the passenger compartment communicates with the computer for selecting video images to be displayed. A second vertical video display is preferably provided opposite the first vertical video display at the opposing end of the passenger compartment. Additional overhead displays may be added to expand the size of the image displayed overhead. An air cooling duct is formed above the overhead display for passage of cooled air.

### BACKGROUND OF THE INVENTION

### Field of the Invention

The present invention relates generally to video display systems for passenger vehicles, and more particularly, to a full-immersion video system for multi-passenger vehicles, including limousines, vans, buses, private airplanes, personal watercraft, and the like.

### Description of the Related Art

Video entertainment systems featuring relatively large flat panel video screens are now commonplace in the home and commercial establishments. The large flat panel video screens are typically mounted to a vertically extending wall of the home or business. These systems may impose significant power demands, but are supplied with stable AC electrical power from the utility company that services the home or business. In addition, the associated flat panel screen is typically mounted to a fixed, non-movable wall, and the audio-visual (AV) controller used to drive such systems is also typically maintained in a fixed location.

Smaller video players are also available for entertaining passengers in the rear seating area of passenger vehicles. These smaller video players may either be permanently mounted, or removably secured, within the vehicle. In either case, such smaller video players are typically mounted in a manner that avoids distraction of the driver seated in the front seat of the vehicle. Such smaller video players have modest power requirements, and are adapted to use the 12 volt electrical supply found in most vehicles.

Efforts have been made to equip multi-passenger vehicles, e.g., limousines, with relatively large flat panel televisions. In limousines and other multi-passenger vehicles, distraction of the vehicle driver is of lesser concern, since the passenger compartment is often divided from the driver's compartment, and the driver is not dependent upon the use of a rear view mirror having a line of sight that passes through the vehicle itself. Those existing limousines known to the applicant which have included a large screen flat panel television have mounted such television in a vertical plane, either on the forward wall that separates the passengers from the driver, or on the rear wall of the vehicle. While seating arrangements within limousines can vary, passengers most often sit either facing the front of the vehicle or facing the rear of the vehicle; when passengers are seated facing in opposing directions, only some of the passengers will be able to view the screen.

Installing large flat panel screens within moving vehicles gives rise to a host of technical challenges. Large flat panel screens are usually designed to receive electrical power at voltages commonly found in the home; in the United States, this is typically 110 volts AC. In addition, large flat panel screens are designed to operate at or near typical room temperature, whereas the temperature within a vehicle may skyrocket if the vehicle is left in a sunny place. Such high temperatures will prevent such screens from displaying images properly.

There is growing interest in full immersion video wherein a user is surrounded in images. Virtual reality (VR) goggles are becoming more commonplace for use in experiencing video games and engaging in computer simulations. While VR goggles provide a perception of being surrounded by video images, it would clearly be preferable not to require a user to wear goggles in order feel immersed in a video display.

It is known to combine two or more flat screen panels to form a larger image. For example, Planar Systems, Inc. of Beaverton, Oregon, designs and sells so-called video wall systems formed from an array of flat screen panel units. Typically, such video wall systems are formed of a number of flat screen panels mounted edge-to-edge in a single vertical plane. In at least some instances, such video wall systems “turn a corner”, i.e., one or more flat screen panels are arranged in a first vertical plane, and a second group of flat screen panels are arranged in a second intersecting vertical plane, to better surround a user by a video image. Such video surround systems typically require a computer, in the form of a wall processor or media player, and related software, to coordinate the images displayed by such flat screen panels. These known systems are designed for use indoors in a non-moving, fixed environment, with stable power supplies, and not for use within a moving vehicle.

Accordingly, it is an object of the present invention to provide a full-immersion video system adapted for use within a moving vehicle.

Another object of the present invention is to provide a suitable power supply for operating such a full-immersion video system within a moving vehicle.

A further object of the present invention is to provide such a full-immersion video system within a moving vehicle in a manner that does not endanger occupants of the vehicle.

Still another object of the present invention is to provide such a full-immersion video system within a moving vehicle in a manner that facilitates viewing by forward-facing passengers and by rearward-facing passengers.

Yet another object of the present invention is to provide such a full-immersion video system within a moving vehicle and adapted to function relatively quickly even when the vehicle has been left in direct sunlight during summer months.

These and other objects of the present invention will become more apparent to those skilled in the art as the description of the present invention proceeds.

### SUMMARY OF THE INVENTION

Briefly described, and in accordance with the preferred embodiments thereof, the present invention relates to a passenger vehicle including a full-immersion video display system. The vehicle includes a passenger compartment having at least one passenger seat. An overhead video display screen is mounted in a generally horizontal plane proximate to the roof of the vehicle within an upper portion of the passenger compartment. A vertical video display screen is also provided, and is mounted in a generally vertical plane within the passenger compartment, proximate to one of the forward or rearward portions of the overhead video display screen. A computer is mounted within the vehicle and coupled to the overhead and vertical video display screens for sending coordinated video images to be displayed upon the overhead and vertical video display screens. The displayed images appear to travel continuously between the horizontal plane of the overhead video display screen and the vertical plane of the vertical video display screen, and vice versa.

In a preferred embodiment, a control panel having a touch-sensitive screen is also provided. The control panel communicates with the computer for selecting video images to be displayed upon the overhead and vertical video display screens.

In one embodiment, the first passenger seat faces toward the front end of the vehicle, and the vertical video display screen is mounted proximate the front end of the passenger compartment. In an alternate embodiment, the first passenger seat faces toward the rear end of the vehicle, and the vertical video display screen is mounted proximate the rear end of the passenger compartment. In yet another embodiment, two vertical video display screens are provided, one being mounted near the front end of the passenger compartment, and the other being mounted near the rear end of the passenger compartment; both of such vertical video display screens are coupled to the aforementioned computer to coordinate the video images displayed by the overhead video display screen and the two vertical video display screens. Images appear to travel between the horizontal plane of the overhead video display screen and the vertical planes of the front and rear vertical video display screens.

A second passenger seat may be provided, and the first and second passenger seats may face each other; the first passenger seat may face the front end of the passenger compartment, and the second passenger seat may face the rear end of the passenger compartment.

Preferably, the video image displayed overhead is expanded by including a second overhead display screen. The second overhead display screen is also mounted in a generally horizontal plane proximate to the roof of the vehicle within the upper portion of the passenger compartment. Ideally, the first and second overhead video display screens are mounted in the same horizontal plane, with the rearward edge of the first overhead video display screen lying substantially adjacent the forward edge of the second overhead video display screen to form a substantially continuous horizontal display panel. Both the first and second overhead video display screens are coupled to the computer, and the computer sends coordinated video images to be displayed upon the first and second overhead video display screens, and on the associated vertical display screens, to display images that appear to travel between the composite horizontal display panel formed by the first and second overhead video display screens and the vertical planes of the vertical video display screens.

In the preferred embodiment, a horizontal support frame is secured within the passenger compartment of the vehicle below the vehicle roof for supporting one or more overhead video display screens. The horizontal support frame is spaced apart from the vehicle roof to create an air duct between the vehicle roof and the overhead video display screens. Cooled air is circulated to the air duct for removing heat above the overhead video display screens.

In the preferred embodiment, electrical power to operate the video display screens and the aforementioned computer is provided by one or more electrical storage batteries that are re-charged by the alternator of the vehicle. Low-voltage D.C. electrical power stored by the batteries is converted by a sine wave power inverter into higher voltage alternating current (e.g., 110 Volt A.C.); preferably, the A.C. power is provided to a surge protector before being supplied to the power supply inlets of the video display screens and the computer that controls them. In the preferred embodiment, an audio system is also provided in the passenger compartment to provide audio sound signals coordinated with the video images; the audio system is preferably powered directly from the low voltage D.C. electrical supply to avoid introduction of 60-cycle “hum” into the audio processing components.

### BRIEF DESCRIPTION OF THE DRAWINGS

FIG. 1 is a perspective view of the exterior of a land vehicle suitable for use in practicing the present invention.

FIG. 2 is another perspective view of the land vehicle shown in FIG. 1.

FIG. 3 is a cutaway side view of the land vehicle shown in FIGS. 1 and 2 illustrating a first embodiment of the present invention.

FIG. 4 is an alternate view of the passenger seats, video display screens, and control components of FIG. 3.

FIG. 5 is a simplified representation of the embodiment of the invention shown in FIGS. 3 and 4.

FIG. 6 is a simplified representation of a second embodiment of the invention which includes both front and rear display screens in addition to at least one overhead display screen.

FIG. 7 is a simplified representation of a third embodiment of the invention wherein a second overhead display screen is included, in addition to the front and rear screens.

FIG. 8 is a perspective view of the embodiment represented by FIG. 7, and including both forward-facing and rearward-facing passenger seats.

FIG. 9 is a block diagram of the electrical power components used to supply electrical power to a video effects computer, to the video display panels, and to a related audio sound system.

FIG. 10 is a front view of an empty ventilated case for a computer used to control the video display panels in a preferred embodiment of the present invention.

FIG. 11 is a front view of the case shown in FIG. 10 after the effects computer and power supply have been added thereto.

FIG. 12 is an upper perspective view of the computer case shown in FIG. 11 and showing the cooling fan used to cool the computer case, as well as a CPU cooling fan for dissipating heat generated by the CPU.

FIG. 13 is a close-up perspective view of the CPU cooling fan.

FIG. 14 is a front view of a touch screen tablet device linked to the video effects computer for allowing a passenger to control the operation of the video display system.

FIG. 15 is a perspective view of a support frame adapted to safely support two video display panels generally proximate to the ceiling of the land vehicle.

FIG. 16 is an alternate view of the support frame shown in FIG. 15 and including an insulative skirt for sealing the sides of the overhead display panels to the sidewalls of the land vehicle.

FIG. 17 is a sectional view of the upper portion of the passenger compartment within the land vehicle.

FIG. 18 is a close-up view of the area designated with in the dashed circle 18 in FIG. 18.

FIG. 19 is an end view of the rear floor area within the passenger compartment and showing an evaporator used to provide cooled air for cooling the overhead video display panels.

FIG. 20 is a perspective view of the rearmost portion of a sidewall of the land vehicle, and showing the passage of air venting tubes from the floor-mounted evaporator of FIG. 19 up to an air duct formed above the overhead video display panels.

### DETAILED DESCRIPTION OF THE PREFERRED EMBODIMENTS

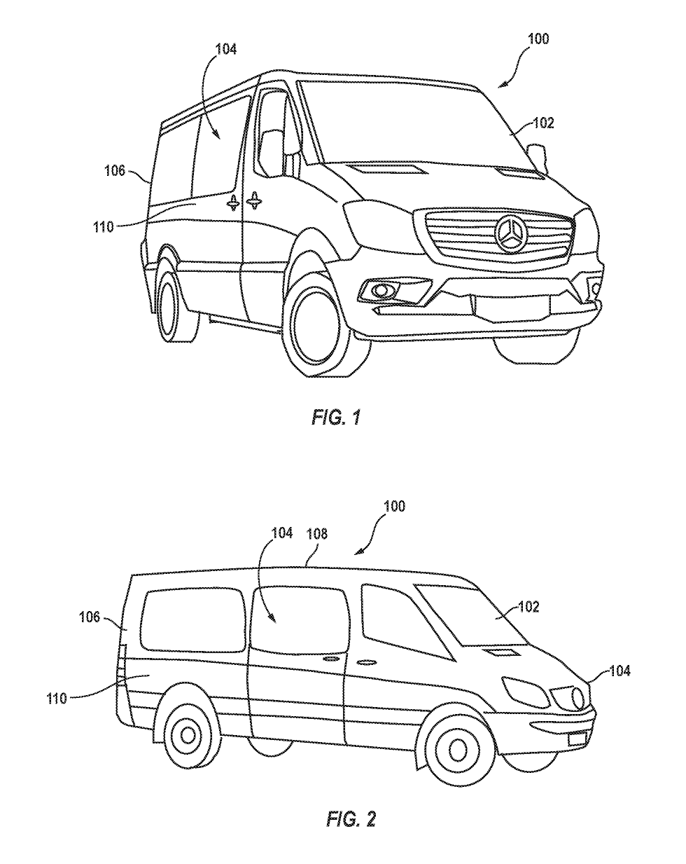

Referring to FIGS. 1 and 2, vehicle 100 is a land-based passenger vehicle suitable for use in practicing a preferred embodiment of the present invention. By way of example, vehicle 100 may be a Mercedes-Benz “Sprinter” brand vehicle which may be easily converted to provide a luxury limousine. Vehicle 100 includes a frontmost driver cab portion 102 and a passenger compartment 104 behind driver cab 102. Vehicle 100 includes a front end 104 and an opposing rear end 106. Vehicle 100 includes a roof 108, and opposing side walls, including side wall 110 shown in FIGS. 1 and 2. Those skilled in the art should note that, while vehicle 100 is shown as a wheeled land-based vehicle, the present invention may extend to other forms of moving vehicles, including buses, private airplanes, personal water craft, and the like.

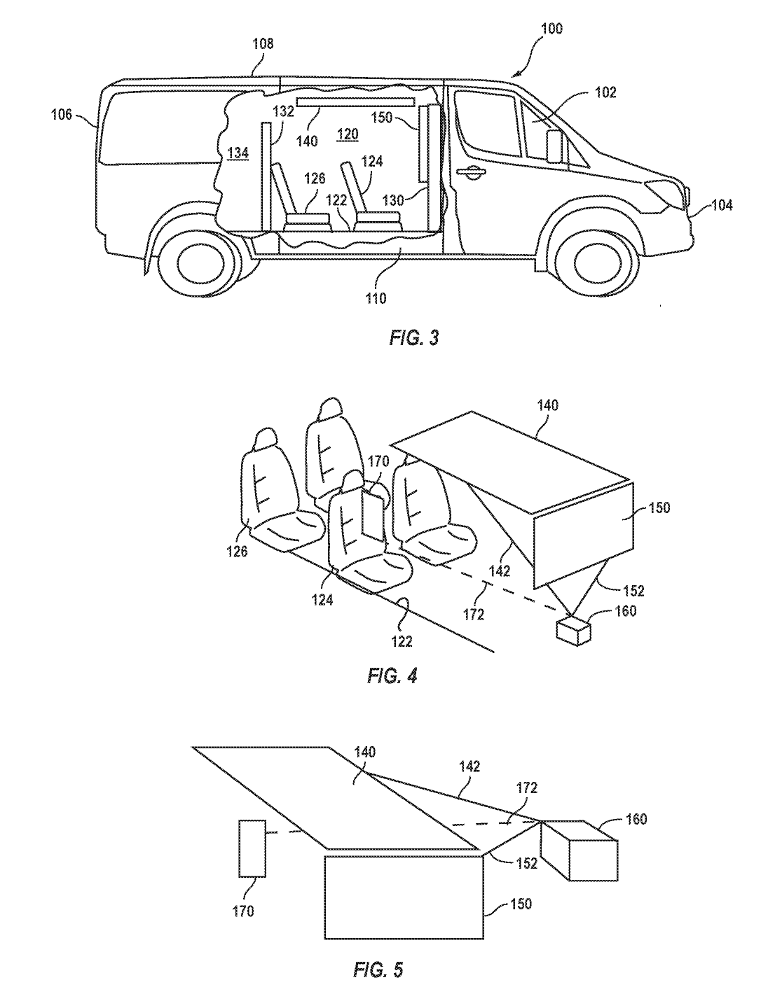

Now turning to FIG. 3, side wall is partially cut away to illustrate passenger compartment 120 of vehicle 100. Passenger compartment 120 includes a floorboard 122. Two rows of passenger seats 124 and 126 are illustrated in FIG. 3; in this example, all of the passenger seats are facing forward, i.e., toward the front end 104 of vehicle 100. If desired, a front wall 130 may be installed at the forward end of passenger compartment 120 to physically separate driver cab 102 from passenger compartment 120. Similarly, a rear wall 132 may be installed at the rearward end of passenger compartment 120 to create a separate luggage storage area 134 behind wall 132. While not shown, the rear end 106 of vehicle 100 may include cargo doors providing access to luggage storage area 134. The floor and side walls of luggage storage area 134 may also be used to contain air cooling evaporators and flexible duct piping for circulating cooled air above the passenger compartment, as will be described in greater detail below.

Still referring to FIG. 3, an overhead video display screen 140 is mounted in a generally horizontal plane proximate to the vehicle roof 108 within the upper portion of passenger compartment 120; the preferred technique for mounting overhead video display screen 140 will be described below in conjunction with FIGS. 15-18. Also, a vertical video display screen 150 is shown mounted in a generally vertical plane proximate to front wall 130 at the forward end of passenger compartment 120; the upper edge of vertical video display screen is preferably disposed closely adjacent the forward edge of overhead video display screen 140. If front wall 130 is present, then vertical video display screen 150 may be mounted directly to front wall 130, or if desired, vertical video display screen 150 may be incorporated within front wall 130. In contrast, if front wall 130 is omitted, then vertical video display screen 150 may be supported by support struts extending from opposing sides of vertical video display screen 150 and opposing side pillars of the vehicle frame located just behind the doors leading to the driver cab portion 102. As will be explained below, vertical display screen could optionally be mounted in a generally vertical plane proximate to rear wall 132 at the rearward end of passenger compartment 120, though passenger seats 124 and 126 might then be positioned to face in a rearward direction. A video effects computer (not shown in FIG. 3) is mounted within vehicle 100, and is electrically coupled to both overhead video display screen 140 and vertical video display screen 150 for sending coordinated video images to be displayed upon overhead video display screen 140 and vertical video display screen 150 to display images that appear to travel between the horizontal plane of overhead video display screen 140 and the vertical plane of vertical video display screen 150.

Now referring to FIGS. 4 and 5, FIG. 4 is a simplified view of passenger compartment 120 of FIG. 3, and FIG. 5 is a further simplified caricature of FIG. 4. Video effects computer 160 is electrically coupled to overhead video display screen 140 and to vertical video display screen 150 for sending coordinated video images to be displayed thereupon. In the preferred embodiment, this electrical coupling is provided by a physical video cable, e.g., an HDMI-style, DVI-style, or DISPLAYPORT-style video cable. Thus, video cable 142 extends between a video card within computer 160 and overhead video display screen 140, and video cable 152 extends between the video card within computer 160 and vertical video display screen 150. The type of video cabling selected must be compatible with the video screens being used and with multi-monitor video display card within computer 160. Preferably, video cables 142 and 152, and video display screens 140 and 150, support 4K video resolution. In some cases, video cables 142 and 152 not only send video signals from computer 160 to display screens 140 and 150, but also transmit status information from display screens 140 and 150 back to computer 160.

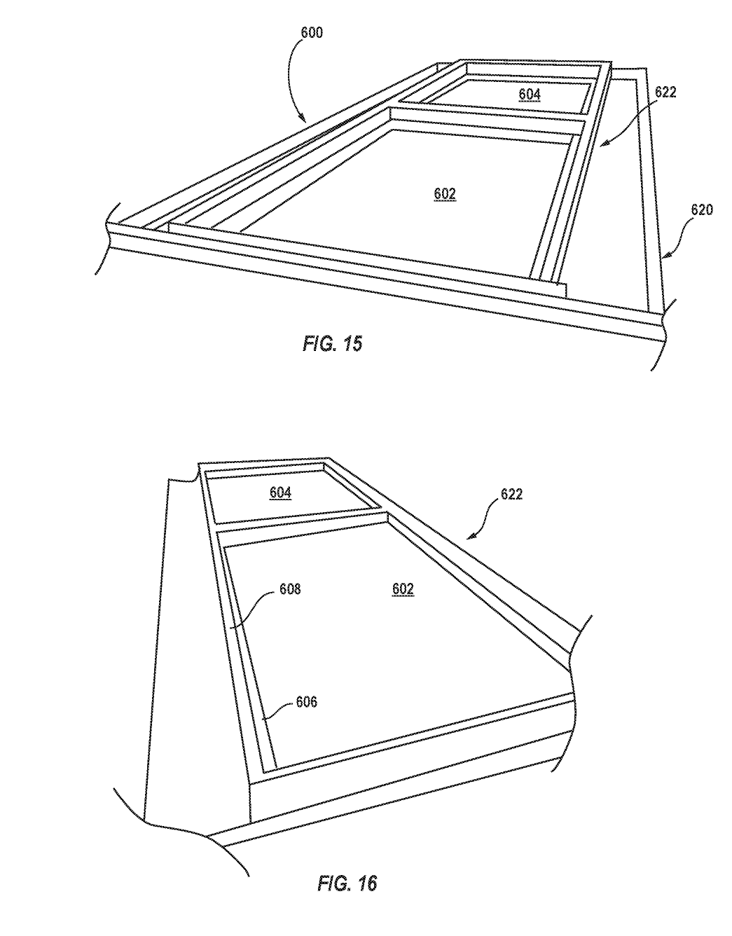

In addition, a control panel 170 having a touch-sensitive screen is provided within passenger compartment 120; preferably, control panel 170 is permanently mounted within the sidewall panel liner for easy access by passengers in passenger compartment 120. Control panel 170 is in communication with computer 160 for allowing a passenger to select video images to be displayed. The front face of control panel 170 is shown in FIG. 14, and the start-up screen may resemble that of a conventional “tablet” computer. A passenger can touch icons displayed on control panel 170 to select the source of video images to be displayed, and to start, pause, and re-start a selected video source. Preferably, the “text app” size of the screen on control panel 170 is set between 150 and 300 pixels, since smaller icons are difficult to manipulate while the vehicle is moving. Preferably, a video cable extends between control panel 170 and video effects computer 160, as shown in by dashed line 172 in FIGS. 4 and 5. In the preferred embodiments described above, control panel 170 is of the type commercially available from GeChic under Model Number 1002 10.1″ Portable Touchscreen Monitor with HDMI and VGA Inputs.

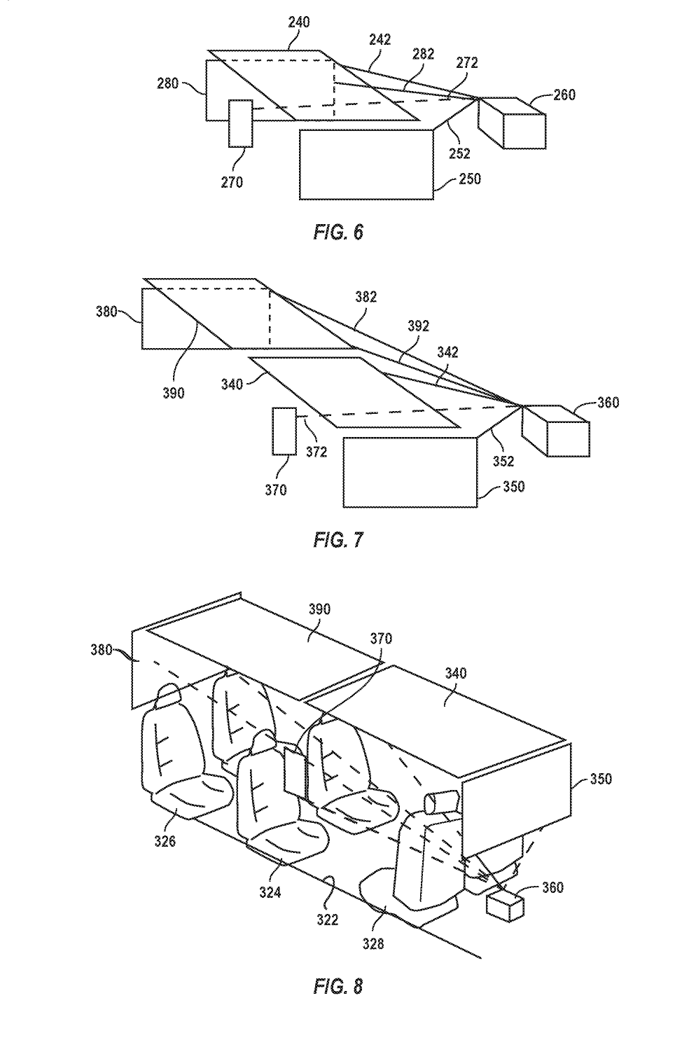

FIG. 6 and FIG. 7 are simplified system caricatures, similar to that of FIG. 5, for two alternate embodiments of the present invention. In FIG. 6, the video display system still includes an overhead video display screen 240 and a forward vertical video display screen 250, but also includes a rearward vertical video display screen 280, which is also coupled to computer 260 by video cable 282. In this instance, passengers may be seated in both forward-facing and rearward-facing directions, or passenger seats may be installed against one side of the passenger compartment to permit each passenger to view both overhead video screen 240 and vertical screens 250 and 280 simultaneously. If rear partition wall 132 (see FIG. 3) is present, then rearward vertical video display screen 280 can be secured directly to, or incorporated within, rear partition wall 132. If rear partition wall 132 is omitted, then rearward vertical video display screen 280 is mounted inside a steel case having support struts bolted to the opposing rear side pillars of the vehicle frame.

The embodiment shown in FIGS. 7 and 8 is expanded over the system of FIG. 6 to include an additional overhead video display screen. As in FIG. 6, the expanded system of FIG. 7 includes a forwardmost overhead video display screen 340, forward vertical video display screen 350, and a rearward vertical video display screen 380, all of which are electrically coupled to computer 360 by appropriate video cables (342, 352, 382). In addition, a second, rearmost overhead video display screen 390 has been added. Also, a third row of passenger seats 328 has been added, this time facing the rear of the passenger compartment. Like the first overhead video display screen 340, second overhead video display screen 390 is mounted in a generally horizontal plane proximate to roof 108 of vehicle 100, within the upper portion of the passenger compartment; preferably, display screens 340 and 390 are mounted in the same horizontal plane, with the rearward edge of first overhead video display screen 340 lying substantially adjacent the forward edge of the second overhead video display screen 390 to form a substantially continuous composite horizontal display panel. Second overhead video display screen 390 is also electrically coupled to computer 360 by an appropriate video cable, and computer 360 sends coordinated video images to be displayed upon the first and second overhead video display screens 340 and 390, and upon the first and second vertical video display screens 350 and 280 to display images that appear to travel substantially continuously between the composite horizontal display panel formed by screens 340 and 390 and the vertical planes of the first and second vertical video display screens 350 and 380.

In the preferred embodiments described above, the overhead display panels (140, 240, 340) are preferably of the type commercially available from Samsung Electronics under Model Number UN65MU8000 65-Inch 4K Ultra HD Smart LED TV. Also, the vertical display panels (150, 250, 350, 280, 380) are preferably of the type commercially available from Samsung Electronics under Model Numbers UN40MU6300 40-Inch 4K Ultra HD Smart LED TV. While these models are used in the preferred embodiment, Applicant's invention is in no way limited thereto.

Also in the preferred embodiments, the video card included in the video effects computer (160, 260, 360) is preferably of the type commercially available from ASUS as Model Number Dual Series GeForce GTX 1060 DUAL-GTX1060-03G 3GB 192-Bit GDDRS PCI Express 3.0 HDCP Ready Video Card. This particular video card is compatible with computer motherboards using a Mini-ITX form factor and includes two on-board self-cooling fans. It provides four digital video output ports that have two-way communication, namely, two HDMI ports and two DISPLAYPORT-style ports. Two-way communication between the display televisions and the video card allows the television electronics to “talk” to the video card and supply it with information needed by the computer (160, 260, 360) to send the correct video settings and data to each of the display screens.

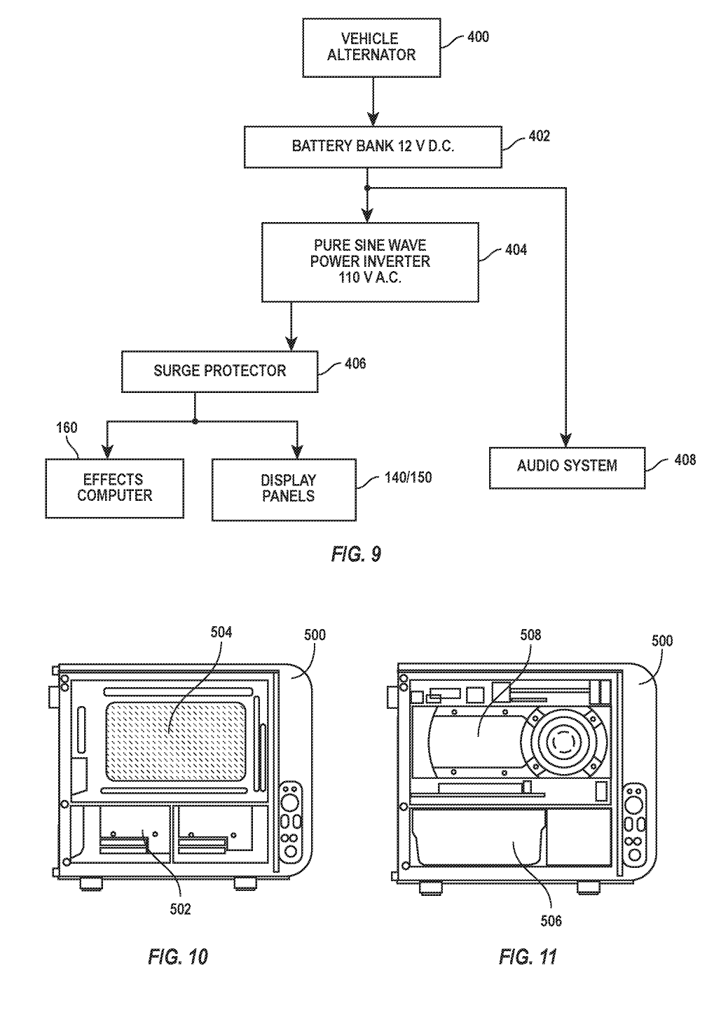

FIG. 9 is a block diagram illustrating the electrical power supply system that is used to power components of the full-immersion video system described above. Vehicle 100 (see FIG. 1) has an engine that includes an alternator 400. Vehicle 100 also includes a conventional lead storage battery prior to installation of the full-immersion video system. However, OEM alternators are typically ill-equipped to handle additional loads from aftermarket equipment and upgrades. This might lead to anything from dim headlights, severe drivability problems, and/or causing the alternator to burn out altogether. The alternator used in vehicle 100, including the full-immersion video system, is preferably capable of providing sufficient amperage to power the components of the full-immersion video system even when the vehicle motor is idling.

To better safeguard against insufficient amperage during engine idle conditions, vehicle 100 (see FIG. 1) preferably includes a battery storage bank, item 402 in FIG. 9, for storing a larger amount of electrical power than is possible using only the OEM storage battery normally provided by the vehicle manufacturer. Battery storage bank 402 is fully-charged by alternator 400 when vehicle 100 is driven at normal operating speeds, and can supply a greater amount of amperage when the output of alternator 400 is reduced during idling conditions. At vehicle startup, vehicle 100 will have its own startup load on alternator 400; supplemental battery bank 402 allows the full-immersion video system to remain stable by supplying the excess electricity needed to allow the system to boot-up and operate more quickly.

As an alternative, one may install a dual alternator kit within the engine compartment of the vehicle. Using this option, the first alternator is used solely to charge the original OEM battery, and does not supply electrical power for the video system components. The second alternator supplies electrical power only for the load added by the video system components, and charges a separate battery bank dedicated only to the video system components.

The low-voltage D.C. supply provided by battery bank 402, which is usually about 12 volts for vehicles used in the U.S., is provided to a pure sine wave power inverter 404 for generating a higher voltage alternating current supply, like the 110 volt A.C. wall outlet voltage that is found in most homes in the U.S. The video display panels described above, and the power supply input cord for the video effects computer, are all designed to receive a 110 volt A.C. power supply, and inverter 404 performs that function. Inverter 404 is selected to supply a consistent form of AC power to the video system components, even upon initial engine start-up, when the power load tends to spike, both because of the demands of the vehicle itself plus the initial boot-up of the added video system. In the preferred embodiments described above, inverter 404 is of the type commercially available from Samlex America under Model Number PST-600-12, and is capable of providing 600 Watts of power.

As shown in FIG. 9, the A.C. voltage generated by inverter 404 is preferably provided to a surge protector 406. Not only does surge protector 406 offer additional protection against power surges, but it also provides extra power outlet sockets compared to only one or two outlets provided by inverter 404. Surge protector 406 provides additional protection in the event that one of the components of the video system fails due, for example, to a short circuit within one of such components. As indicated in FIG. 9, power inlet cords from the video effects computer 160 and from the video display screens 140/150 are plugged directly into the outlets provided by surge protector 406.

Still referring to FIG. 9, it has been noted that the full-immersion video system provided by the present invention is intended to be used in conjunction with an audio sound system installed in the passenger compartment of the vehicle. As shown in FIG. 9, audio sound system 408 is preferably powered directly from low-voltage battery bank 402, thereby avoiding introduction of any low frequency (e.g., 60-cycle) A.C. “hum” into the audio processing components.

FIG. 10 of the drawings illustrates a computer case particularly adapted to house the video effects computer. Computer case 500 includes a lower chamber 502 for housing an electrical power supply, and a larger upper chamber for housing a computer motherboard, CPU and video card. Due to the amount of heat generated by the CPU and display card, case 500 requires significant cooling. Case 500 is preferably perforated at least 50% on each of its side to allow air to move across the computer components to cool them, and then exhaust the air back outside the computer. Case 500 uses “chamber ventilation” technology to put the computer power supply within lower chamber 502 of case 500, while keeping the computing portion of the computer in upper chamber 504, thereby allowing more effective removal of heat. In the preferred embodiments described above, computer case 500 is a Thermaltake Core V1 Black Edition SPCC Mini ITX Cube Computer Chassis, Model CA-1B8-00S1WN-00.

In FIG. 11, the computer power supply 506 is shown installed in the lower chamber 504 of case 500. Also in FIG. 11, the computer components themselves are designated by 508, and are installed in upper chamber 504 of case 500.

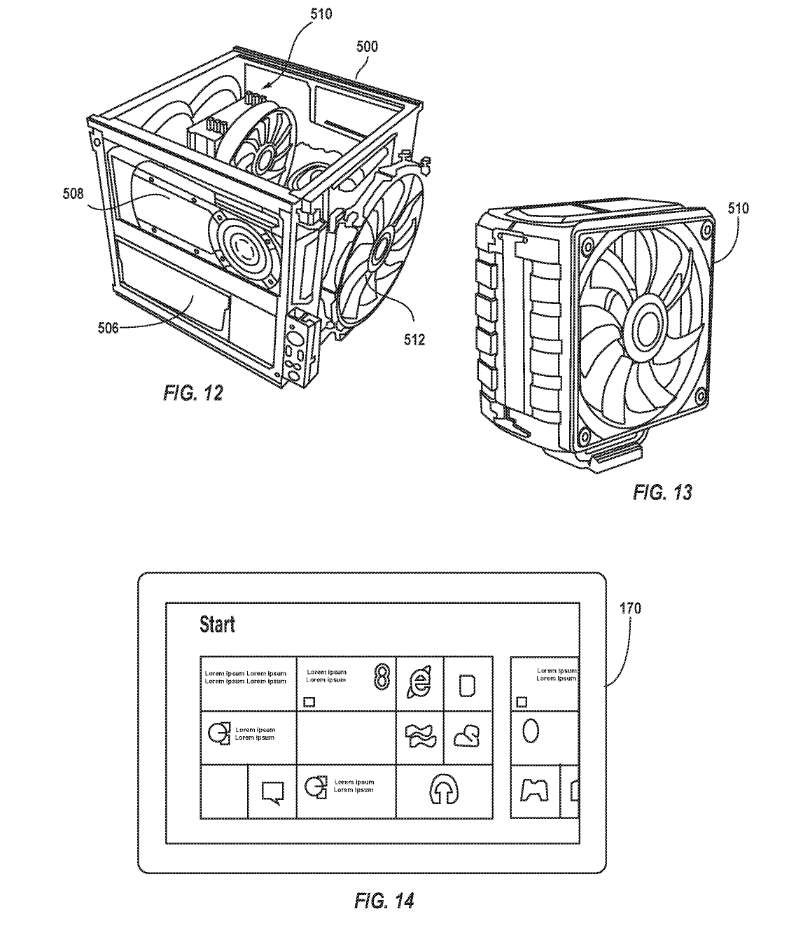

FIG. 12 is a partial perspective view of computer case 500 after the side walls are removed. In the preferred embodiments, the CPU is of the type commercially available from Intel Corporation as the Model Core i7 6700K 4.00 GHz Unlocked Quad Core Skylake Desktop Processor, having an LGA 1151 socket configuration. The CPU is served by a computer gaming motherboard of the type commercially available from ASUS under Model Number ASUS ROG Strix Z2701 and providing a Mini-ITX form factor. The CPU is directly cooled by a heat sink 510 having dual 120 mm. fans of the type commercially available from Thermaltake under Part Number NiC C5 120 mm Untouchable CPU Cooler CLP0608, shown best in FIG. 13; these dual fans push air into, and pull air from, the central heat sink. Heat sink 510 has an independent throttle that can be controlled to raise air movement from 1000 RPM to 2000 RPM if cooling is not adequate. The motherboard has built in heat monitoring and can self-control the RPM of the dual fans of heat sink 510 as needed to maintain satisfactory operation. In addition, as shown in FIG. 12, computer case 500 includes a relatively large fan 512 for pulling air through upper chamber 508 to cool the computing components housed therein, while also removing any heat added thereto by power supply 506.

While not shown, computer 508 preferably makes use of a solid state hard drive, or SSD. Road vibration, bumps, potholes, speed bumps, and the like would play havoc with a conventional spinning hard drive. Since all programs and data are stored digitally on memory chips in an SSD, no information is lost due to road conditions.

Referring now to FIGS. 15 and 16, tubular support frame 600 is shown for supporting two overhead video display screens safely above the passengers seated in the passenger compartment of the vehicle. Support frame 600 includes an outer steel frame 620 formed of 1″×1″ steel tubular members; this outer frame 600 is welded to the structural frame of vehicle 100, as by welding to the structural vertical pillars that support the side walls and roof of the vehicle. Outer steel frame 620 receives an aluminum tubular inner frame 622 which has two central cavities, 602 and 602, formed therein, and lying closely adjacent each other in end-to-end relationship. Cavity 602 is adapted to receive overhead video display 340 (see FIGS. 7 and 8), while cavity 604 is adapted to receive overhead video display 390. After overhead video display screens 340 and 390 are mounted within cavities 602 and 604, respectively, the rearward edge overhead video display screen 340 lies substantially adjacent the forward edge of overhead video display screen 390, and display screens 340 and 390 are supported in a common horizontal plane, to form a substantially continuous composite horizontal display panel.

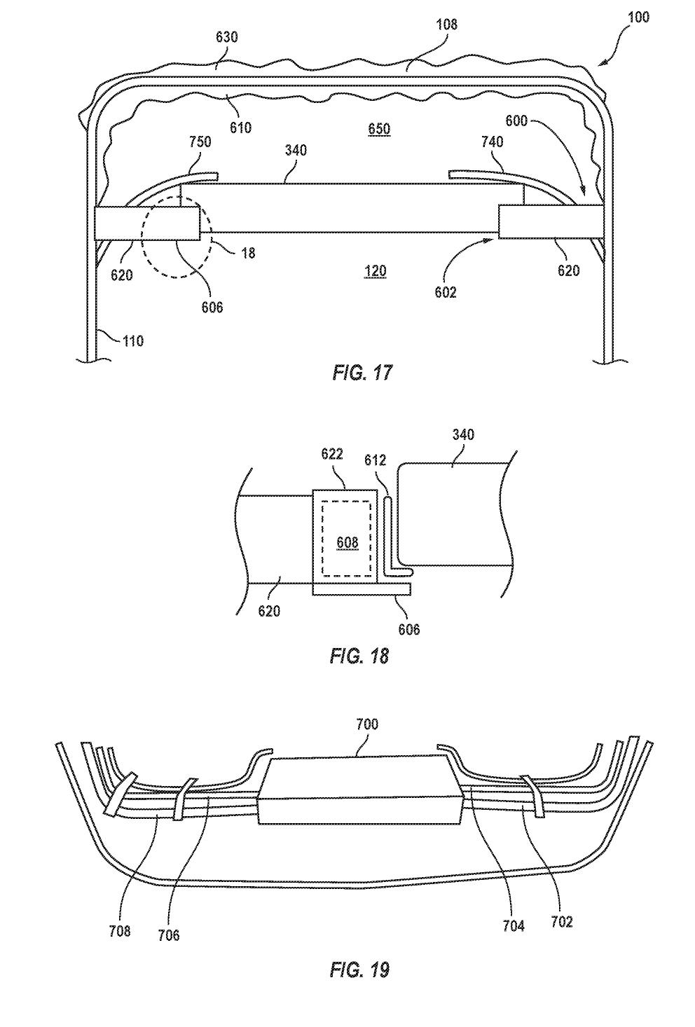

Each of cavities 602 and 604 is surrounded by tubular hollow aluminum members 608 of rectangular cross-section; in the preferred embodiment, these tubular members are one-inch by three-inches in dimension, each having a wall thickness of one-eighth inch. In addition, each such tubular member is provided with a lower, inwardly-projecting lip 606 welded thereto, on which the lower, outer perimeter of the video display panel may rest. Turning briefly to FIGS. 17 and 18, aluminum support frame 120 is shown after being secured to opposing interior side wall pillars of vehicle 100, spaced below roof 108. Video display panel 340 is disposed within cavity 602, and rests upon lip 606. To minimize shock and/or vibration due to movement of vehicle 100, a layer of cushioning material is interposed between each overhead video display screen and the supporting lip of the horizontal support frame. As shown best in FIG. 18, cushioning material 612 is inserted between video display panel 340 and lip 606 to cushion overhead display panel 340 from shock and vibration as the vehicle moves. In the preferred embodiments, cushioning material 612 is 3M brand VHB Tape No. 5952, a durable acrylic adhesive with viscoelastic properties, in the form of a double-sided foam tape. Even when vehicle 100 hits high impact potholes or bumps in the road, the tubular support frame and cushioning tape help to prevent a transfer of impact forces to the face of the display screens that might otherwise create a fracture, crack, or break across the face of the video screen.

During assembly, the outer steel frame 620 is first welded to vehicle 100 below roof 108. After the overhead video display screens are installed in cavities 602 and 604 of inner aluminum frame 622, inner frame 622 is lifted up into outside steel frame 620 and bolted to outer steel frame 620. The use of a welded tubular aluminum inner support frame provides increased stability and uniform control of movement when the body of the vehicle twists due to road conditions.

As already noted above, the overhead video display screens 340 and 390 are mounted near the roof 108 of vehicle 100, and roof 108 is typically in direct sunlight absorbing heat into the vehicle continuously. Video display panels are not designed to operate in high heat conditions. Furthermore, high definition flat panel televisions typically employ computer circuitry that is located on the back of the unit without any fan based cooling system. In addition, heat rises, so heat that builds up within vehicle 100 rises toward roof 108. The end result is that overhead video display panels 340 and 390 are located at the warmest place in vehicle 100.

In high heat weather operation, it would typically be impossible to operate the video display system described above. Accordingly special measures must be taken to guard against such conditions. Referring again briefly to FIG. 17, it will be noted that a first layer of thermal insulation 630 is applied to the exterior of roof 108; preferably, layer 630 is of the type sold under the registered trademark Dynamat® thermal and sound insulation. In addition, as also shown in FIG. 17, another layer of thermal insulation 610 is preferably applied to the interior of roof 108 to reduce the amount of heat that transfers through roof 108 into vehicle 100; layer 610 is preferably of the type sold by 3M Corporation under the registered trademark Thinsulate® thermal and sound insulation.

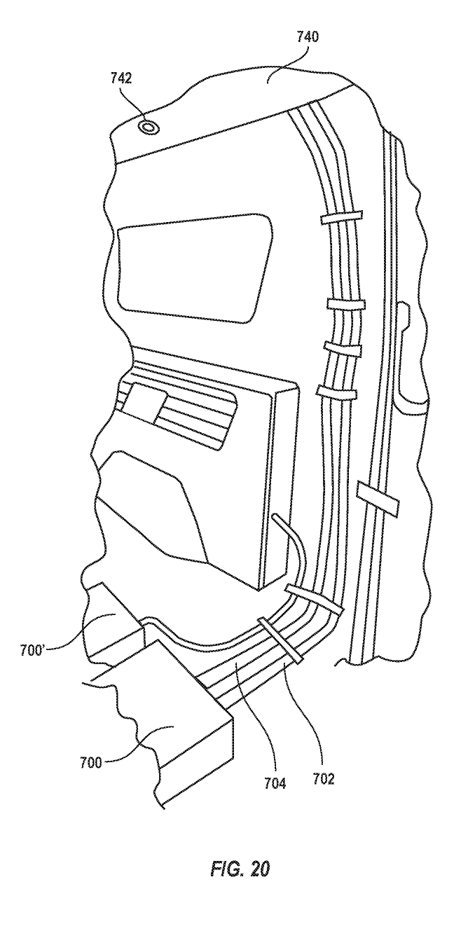

As further shown in FIG. 17, horizontal support frame 600 is spaced apart from vehicle roof 108 to create an air duct 650 between vehicle roof 108 and overhead video display screens 340 and 390, just above the passenger compartment. Referring to FIGS. 19 and 20, a cooling system for duct 650 is shown. One or more evaporators 700 are mounted to the floor of vehicle 100, preferably near rear end 106 of vehicle 100. Evaporators 700 are coupled with an air conditioning compressor system for absorbing heat from air passed therethrough. Evaporators 700 include blowers for forcing cooled air into flexible duct pipes 702, 704, 706, and 708, which are then routed upwardly along the side walls of the vehicle for communication with upper duct 650 for discharging cooled air into the space above the passenger compartment, and above overhead video display screens 340 and 390. The cooled air circulated through upper duct 650 prevents overhead video display screens 340 and 390 from overheating.

As shown in FIGS. 17 and 20, a pair of shrouds 740 and 750 are provided on either side of video display panels 340 and 390 along the length of the passenger compartment. A series of spaced vent holes, including vent hole 742 in FIG. 20, are formed along such shrouds, allowing cooled air blown into duct 650 to circulate back into the passenger compartment along the vehicle windows, in much the same way that air is circulated into an airplane passenger cabin. By directing cooled air first into duct 650, and then blowing such air back into the passenger compartment, the warmest air below the roof is cooled first, after which such air cools the passenger compartment. This approach insures that the components of the video system stay cool and functional in extreme temperature conditions.

It should be noted that each of the display screens mounted in the vehicle, whether overhead or vertical, must be capable of adapting to the same resolution as the other screens employed in the design. In full video immersion, the video image that is moving through each display screen must appear as if the multiple display screens are one big screen, and not several; separate screens. Different resolutions across monitors would make the video change shape as it passes trough each seam in the display screen setup. Thus, when configuring video output, it is necessary to consider the sizes, orientations, and resolutions of each such display screen.

In addition, it is preferred that each video display screen provide “SELF BOOT” feature on power-up, i.e., when the electrical power inverter turns on, each of the display screens must self power-on without first being triggered by a remote control unit.

Those skilled in the art will now appreciate that a full immersion video system has been described for use within a moving vehicle while being relatively immune to shock and vibration when driving over bumps or potholes. The described system includes a suitable power supply for operating such a full-immersion video system within a moving vehicle. Moreover, video display screens are supported within the vehicle in a manner that does not endanger occupants of the vehicle. Displayed images can be viewed by both forward-facing passengers and by rearward-facing passengers. Moreover, the full-immersion video system is adapted to function relatively quickly even when the vehicle has been left in direct sunlight during summer months.

While the present invention has been described with respect to preferred embodiments thereof, such description is for illustrative purposes only, and is not to be construed as limiting the scope of the invention. Various modifications and changes may be made to the described embodiments by those skilled in the art without departing from the true spirit and scope of the invention as defined by the appended claims.

1. A passenger vehicle including a full-immersion video display system, comprising in combination:
a) a vehicle having opposing front and rear ends, opposing first and second side walls, and a roof;
b) the vehicle including a driver compartment located near the front end of the vehicle, and a passenger compartment located between the driver compartment and the rear end of the vehicle, the passenger compartment having forward and rearward ends and including at least a first passenger seat adapted to seat a first passenger facing toward the rear end of the vehicle;
c) a first overhead video display screen mounted within the passenger compartment in a generally horizontal plane proximate to the roof and within an upper portion of the passenger compartment;
d) a first vertical video display screen mounted within the passenger compartment in a generally vertical plane proximate to the rearward end of the passenger compartment;
e) a computer mounted within the vehicle and coupled to the first overhead video display screen and to the first vertical video display screen for sending coordinated video images to be displayed within the passenger compartment, and not within the driver compartment, upon the first overhead video display screen and the first vertical video display screen to display images that appear to travel between the horizontal plane of the first overhead video display screen and the vertical plane of the first vertical video display screen.

2. The passenger vehicle recited in claim 1 further including a control panel within the passenger compartment and having a touch-sensitive screen, the control panel being in communication with the computer for selecting video images to be displayed upon the first overhead video display screen and the first vertical video display screen.

3. The passenger vehicle recited in claim 1 wherein a second vertical video display screen is mounted proximate to the forward end of the passenger compartment.

4. (canceled)

5. The passenger vehicle recited in claim 1 wherein:
a) the passenger compartment includes at least a second passenger seat facing toward the rear front end of the vehicle; and
b) a second vertical video display screen is mounted in a generally vertical plane proximate to the forward end of the passenger compartment, the second vertical video display screen also being coupled to the computer, and the computer sending coordinated video images to be displayed upon the first overhead display screen, and upon the first and second vertical video display screens, to display images that appear to travel between the horizontal plane of the overhead video display screen and the vertical planes of the first and second vertical video display screens.

6. The passenger vehicle recited in claim 1 further including a second overhead video display screen mounted in a generally horizontal plane proximate to the roof and within the upper portion of the passenger compartment, the first and second overhead video display screens each having forward and rearward edges, the rearward edge of the first overhead video display screen lying substantially adjacent the forward edge of the second overhead video display screen to form a substantially continuous composite horizontal display panel, the second overhead video display screen being coupled to the computer, and the computer sending coordinated video images to be displayed upon the first and second overhead video display screens, and upon the first vertical video display screen to display images that appear to travel between the composite horizontal display panel and the vertical plane of the first vertical video display screen.

7. The passenger vehicle recited in claim 6 wherein:
a) the passenger compartment includes at least a second passenger seat facing toward the front end of the vehicle; and
b) a second vertical video display screen is mounted in a generally vertical plane proximate to the forward end of the passenger compartment, the second vertical video display screen also being coupled to the computer, and the computer sending coordinated video images to be displayed upon the composite horizontal display panel, and upon the first and second vertical video display screens, to display images that appear to travel between the horizontal plane of the composite horizontal display panel video display screen and the vertical planes of the first and second vertical video display screens.

8. A passenger vehicle including a full-immersion video display system, comprising in combination:
a) a vehicle having opposing front and rear ends, opposing first and second side walls, and a roof;
b) the vehicle including a passenger compartment having forward and rearward ends and including at least a first passenger seat
c) a horizontal support frame secured in fixed relationship within the vehicle below the vehicle roof;
d) a first overhead video display screen mounted in a generally horizontal plane proximate to the roof and within an upper portion of the passenger compartment, and wherein the first overhead video display screen is mounted within the horizontal support frame in a fixed horizontal position;
d) a first vertical video display screen mounted in a generally vertical plane proximate to one of the forward and rearward ends of the passenger compartment
e) a computer mounted within the vehicle and coupled to the first overhead video display screen and to the first vertical video display screen for sending coordinated video images to be displayed upon the first overhead video display screen and the first vertical video display screen to display images that appear to travel between the horizontal plane of the first overhead video display screen and the vertical plane of the first vertical video display screen.

9. The passenger vehicle recited in claim 8 including a second overhead video display screen mounted in a generally horizontal plane proximate to the roof and within the upper portion of the passenger compartment, the first and second overhead video display screens each having forward and rearward edges, the rearward edge of the first overhead video display screen lying substantially adjacent the forward edge of the second overhead video display screen to form a substantially continuous composite horizontal display panel, and wherein the second overhead video display screen is mounted within the horizontal support frame.

10. The passenger vehicle recited in claim 8 wherein the horizontal support frame is spaced apart from the vehicle roof to create an air duct between the vehicle roof and the first overhead video display screen, and wherein the vehicle further includes at least one air blower for blowing cooled air through the air duct to avoid overheating the first overhead video display screen.

11. The passenger vehicle recited in claim 8 including a layer of cushioning material interposed between the first overhead video display screen and the horizontal support frame to cushion the first overhead display panel from shock and vibration as the vehicle moves.

12. A passenger vehicle including a full-immersion video display system, comprising in combination:
a) a vehicle having opposing front and rear ends, opposing first and second side walls, and a roof;
b) the vehicle including a passenger compartment having forward and rearward ends and including at least a first passenger seat;
c) a first overhead video display screen mounted in a generally horizontal plane proximate to the roof and within an upper portion of the passenger compartment;
d) a first vertical video display screen mounted in a generally vertical plane proximate to one of the forward and rearward ends of the passenger compartment;
e) a computer mounted within the vehicle and coupled to the first overhead video display screen and to the first vertical video display screen for sending coordinated video images to be displayed upon the first overhead video display screen and the first vertical video display screen to display images that appear to travel between the horizontal plane of the first overhead video display screen and the vertical plane of the first vertical video display screen;
f) at least one electrical storage battery storing low-voltage D.C. electrical power;
g) a sine wave power inverter coupled to the at least one electrical storage battery storing low-voltage D.C. electrical power for producing a higher voltage A.C. electrical supply;
h) wherein the higher voltage A.C. electrical supply is coupled to the first overhead video display screen and to the computer for supplying electrical power thereto; and
i) an audio sound system for producing audio signals within the passenger compartment synchronized with the displayed video images, the audio sound system being coupled to the at least one electrical storage battery for receiving the low-voltage D.C. electrical power to avoid introduction of low frequency A.C. “hum” into the audio sound system.

13. (canceled)
